(19) United States
(12) Patent Application Publication
(10) Pub. No.: US 2020/0314217 A1
(43) Pub. Date: Oct. 1, 2020

(54) IT CLOUD ASSISTED UNIVERSAL LOSSLESS DATA COMPRESSION

(71) Applicant: GM Global Technology Operations LLC, Detroit, MI (US)

(72) Inventor: Ronit Bustin, Kfar Saba (IL)

(73) Assignee: GM Global Technology Operations LLC, Detroit, MI (US)

(21) Appl. No.: 16/371,718

(22) Filed: Apr. 1, 2019

(51) Int. Cl. H04L 29/06; H04L 29/08; H04W 4/44

(52) U.S. Cl. CPC H04L 69/04; H04W 4/44; H04L 67/10

(57) ABSTRACT

A method of data sequence processing assisted by an information technology (IT) cloud platform includes detecting target surroundings, via a first sensor arranged on a first vehicle traversing the target surroundings. The method also includes communicating, to the IT cloud platform via a first electronic controller arranged on the first vehicle, a processed first data set indicative of a characteristic of the detected target surroundings. The method additionally includes merging, on the IT cloud platform, the processed first data set with an IT cloud data set residing on the IT cloud platform to generate a combined data set indicative of the characteristic of the target surroundings. A data sequence processing system assisted by the IT cloud platform is also disclosed.

### INTRODUCTION

The present disclosure relates to universal lossless data compression assisted by an information technology (IT) cloud platform for a data gathering and processing system of a motor vehicle. The subject data gathering and processing system and universal lossless data compression may, but do not have to be, related to autonomous vehicles.

Vehicular automation involves the use of mechatronics, artificial intelligence, and multi-agent systems for perception of the vehicle surroundings and guidance to assist a vehicle's operator. Such features and the vehicles employing them may be labeled as intelligent or smart. A vehicle using automation for complex tasks, especially navigation, may be referred to as semi-autonomous. A vehicle relying solely on automation is consequently referred to as robotic or autonomous. Manufacturers and researchers are presently adding a variety of automated functions to automobiles and other vehicles.

Autonomy in vehicles is often categorized in discrete levels, such as Level 1—Driver assistance—where the vehicle may control either steering or speed autonomously in specific circumstances to assist the driver; Level 2—Partial automation—where the vehicle may control both steering and speed autonomously in specific circumstances to assist the driver; Level 3—Conditional automation—where the vehicle may control both steering and speed autonomously under normal environmental conditions, but requires driver oversight; Level 4—High automation—where the vehicle may complete a prescribed trip autonomously under normal environmental conditions, not requiring driver oversight; and Level 5—Full autonomy—where the vehicle may complete a prescribed trip autonomously under any environmental conditions.

Vehicle autonomy requires increasingly sophisticated perception systems, including various optical equipment and a multitude of sensors to detect objects and other obstacles surrounding the host vehicle, and on-board processors and software for interpretation of captured data. Connectivity of vehicle perception systems to an information technology (IT) cloud platform enables multiple vehicles to have simultaneous and universal access to shared pools of configurable system resources and data for reliable control and operation of subject vehicles. To enable vehicular automation, management of data processing resources is required to efficiently store handle, and transmit large amounts of captured data.

In signal processing, the process of reducing the size of a data file, i.e., bit-rate reduction, is often referred to as data compression. Compression is useful because it reduces resources required to store, handle, and transmit data. In the context of data transmission, data compression is identified as source coding—encoding done at the source of the data before it is stored or transmitted. Data compression involves encoding information using fewer bits than the original representation. Compression may be either lossy or lossless. Lossless compression generally reduces bits by identifying and eliminating statistical redundancy. No information is lost in lossless compression. By comparison, lossy compression reduces bits by removing unnecessary or less important information, but generally leads to lost information.

### SUMMARY

A method of data sequence processing assisted by an information technology (IT) cloud platform includes detecting target surroundings, via a first sensor arranged on a first vehicle traversing the target surroundings, The method also includes communicating, to the IT cloud platform via a first electronic controller arranged on the first vehicle, a processed first data set indicative of a characteristic of the detected target surroundings. The method additionally includes merging, on the IT cloud platform, the processed first data set with an IT cloud data set residing on the IT cloud platform to generate a combined data set indicative of the characteristic of the target surroundings.

The method may also include transmitting the combined data set, from the IT cloud platform to a vehicle communication unit arranged in a second vehicle traversing the target surroundings and having a processor, or encoder, and a second electronic controller, or decoder. and communicating the combined data set to each of the processor and the electronic controller via the vehicle communication unit. Additionally, the method may include communicating the combined data set to each of the processor and the electronic controller via the vehicle communication unit.

The method may additionally include sorting or refining the combined data set on the IT cloud platform according to predetermined criteria, and correlating or matching the sorted combined data set with the raw second data set according to the predetermined criteria prior to transmitting the combined data set to the second vehicle.

The method may further include detecting the target surroundings, via a second sensor, such as a camera, arranged on the second vehicle and in communication with the processor. Additionally, the method may include communicating a raw second data set gathered from the detected target surroundings to the processor via the second sensor. Furthermore, the method may include performing an on-line, in real time, lossless compression of the raw second data set, via the processor or encoder, using the combined data set.

According to the method, the on-line lossless compression of the raw second data set may include employing a context tree weighted (CTW) compression algorithm having a context tree data structure with at least one context node and a context buffer data structure.

Employing the CTW compression algorithm may include determining, independently via each of the processor and the second electronic controller, a weighted probability of occurrence of a symbol in the raw second data set given a current context by using the combined data set to generate an enhanced context tree data structure

The CTW compression algorithm may use a sample-based estimator of probability of occurrence of the symbol (for example as part of a sequence of independent and identically distributed symbols (IID)) for every sub-context defined according to the mathematical expression:

$${P}_{e}^{r} = \int \frac{Γ ( {\sum }_{j} {r}_{j} + \frac{\vert A \vert}{2} )}{{\prod }_{j} Γ ( {r}_{j} + \frac{1}{2} )} {\prod }_{j} {θ}_{j}^{{r}_{j} + {a}_{j}} d θ ,$$

the parameters and variables for which are set forth in detail herein.

According to the method, performing the on-line lossless compression of the raw second data set may include generating a relatively shorter encoded sequence of bits in response to a relatively higher determined probability, and generating a relatively longer encoded sequence of bits in response to a lower determined probability.

The method may additionally include communicating the enhanced context tree data structure to the IT cloud platform via the vehicle communication unit, for example, after the second vehicle has exited the target surroundings.

According to the method, the IT cloud platform may include long-term storage of the combined data set

A data sequence processing system assisted by the IT cloud platform and employing the above-described method is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a plan view of a first autonomous motor vehicle exiting a terrain and a second autonomous motor vehicle entering the terrain, each vehicle employing an information gathering system in communication with a data sequence processing system assisted by an information technology (IT) cloud platform, according to the present disclosure.

FIG. 2 is a schematic depiction of on-line operation of the data sequence processing system shown in FIG. 1, according to the present disclosure.

FIG. 3 is a depiction of a compression algorithm context tree data structure employed by the data sequence processing system to losslessly encode (compress) and decode (decompress) raw data, exemplified by a symbol xₜ shown in FIG. 4, gathered by the second vehicle.

FIG. 4 is a depiction of evaluation of appearance of the symbol xₜ at each node of the context tree data structure for use in the compression algorithm.

FIG. 5 is a flow diagram of a method of data sequence processing assisted by the IT cloud platform shown in FIGS. 1-4, according to the present disclosure.

### DETAILED DESCRIPTION

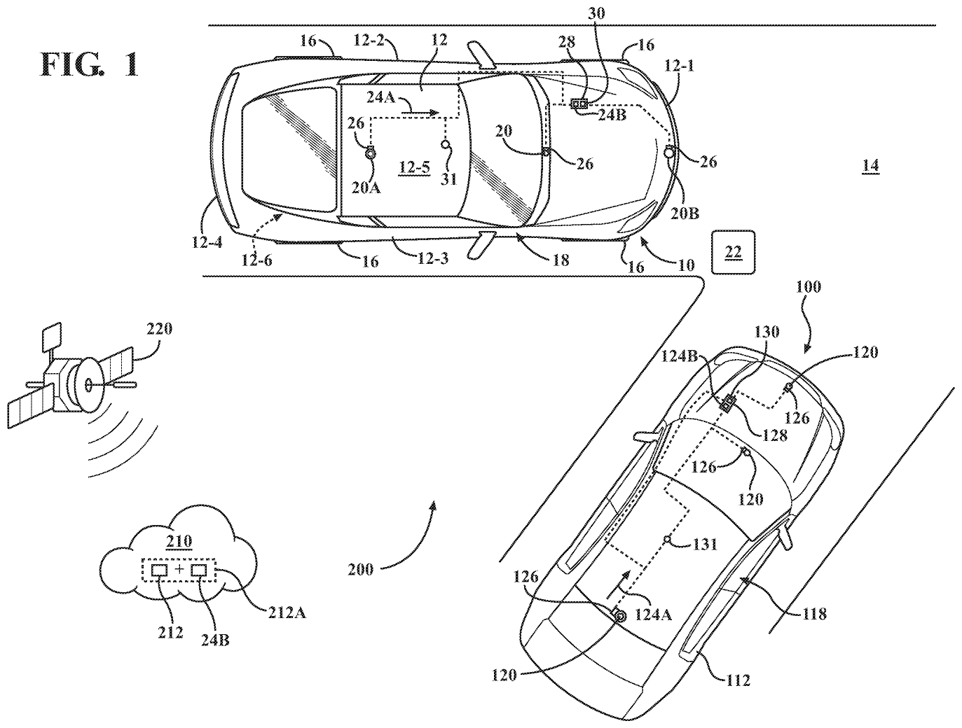

Referring to the drawings, wherein like reference numbers refer to like components, FIG. 1 shows a schematic view of a first motor vehicle 10, which is depicted as an autonomous vehicle. The term “autonomous”, as used herein, generally refers to the use of mechatronics, artificial intelligence, and multi-agent systems to provide varying levels of assistance to a vehicle's operator in controlling the subject vehicle. Such automation may include the entire range of assistance from the vehicle systems controlling either steering or speed autonomously in specific circumstances to assist the operator up to and including full automation which eschews operator involvement.

As shown, the first autonomous motor vehicle 10 has a vehicle body 12. The vehicle body 12 may have a leading side or front end 12-1, a left body side 12-2, right body side 12-3, a trailing side or back end 12-4, a top side or section, such as a roof, 12-5, and a bottom side or undercarriage 12-6. The first vehicle 10 may be used to traverse a road surface within a specific geographical area, defined herein as target surroundings 14, which includes a specific landscape or terrain and associated physical objects. The first vehicle 10 may include a plurality of road wheels 16. Although four wheels 16 are shown in FIG. 1, a vehicle with fewer or greater number of wheels, or having other means, such as tracks (not shown), of traversing the road surface or other portions of the target surroundings 14 is also envisioned.

For example, and as shown in FIG. 1, the first vehicle 10 may use a first information gathering system 18, which may be a perception and guidance system employing mechatronics, artificial intelligence, and a multi-agent system to assist the vehicle's operator. The information gathering system 18 may be used to detect various objects or obstacles in the path of the first vehicle 10. The first information gathering system 18 may employ such features and various sources of data for complex tasks, especially navigation, to operate the first vehicle 10 semi-autonomously, or rely solely on automation to operate the vehicle in a robotic or fully autonomous capacity.

As shown in FIG. 1, as part of the first information gathering system 18, multiple first vehicle sensors 20 are arranged on the vehicle body 12 and used as sources of data to facilitate autonomous operation of the first vehicle 10. Accordingly, the first autonomous vehicle 10 may be identified as a host vehicle to the first vehicle sensor(s) 20. Such first vehicle sensors 20 may, for example, include an acoustic or optical device mounted to the vehicle body 12. Various embodiments of an optical device identified via respective numerals 20A and 20B are shown in FIG. 1. Specifically, such an optical device may be either an emitter 20A or a collector/receiver 20B of light. Either the emitter 20A or the receiver 20B embodiment of the optical device 20 may be mounted to one of the vehicle body sides 12-1, 12-2, 12-3, 12-4, 12-5, and 12-6. The first vehicle sensors 20 are depicted as part of the first information gathering system 18, and may be part of other system(s) employed by the vehicle 10, such as for displaying a 360-degree view of the target surroundings 14.

Specifically, as shown in FIG. 1, the optical device 20 may be a laser beam source for a Light Detection and Ranging (LIDAR) system, and is specifically identified via numeral 20A. Other examples of the subject optical device 20 may be a laser light sensor for an adaptive cruise control system or a camera (also shown in FIG. 1) capable of generating video files, which is specifically identified via numeral 20B. In general, each of the first vehicle sensors 20 is configured to detect the target surroundings 14, including, for example, an object 22 positioned external to the first vehicle 10. Accordingly, the first vehicle sensor 20 is configured to capture a raw first data set 24A gathered from the target surroundings 14.

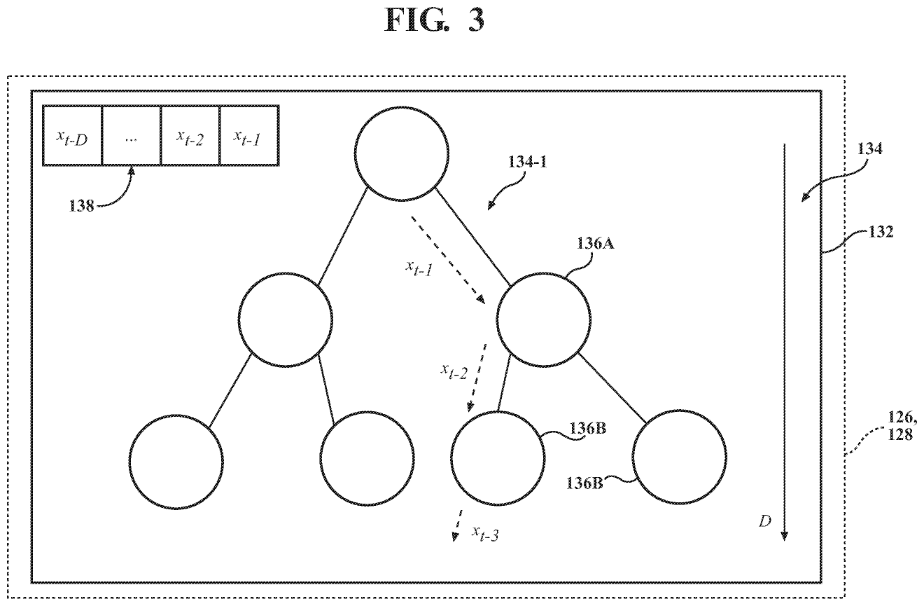

The object 22 may be inanimate, such as a tree, a building, a road or a traffic sign, an animal, or a person. The target surroundings 14 in the vicinity of the first vehicle 10 may include multiple objects (shown in FIG. 3), such as the object 22, information regarding which may be used to assist with navigation of the subject vehicle 10. The sensor(s) 20 may therefore be used to capture raw images and video data, from which specific information regarding various objects, e.g., the object 22, may be extracted via specific algorithms. Each first sensor 20 is also configured to communicate the captured data to a data processor arranged on the first vehicle 10 that will be described in detail below.

With continued reference to FIG. 1, the target surroundings 14 may also be accessed by a second motor vehicle 100. Similar to the first motor vehicle 10, the second vehicle 100 may be an autonomous vehicle, as depicted, and has a vehicle body 112, including similar relevant body sides and road wheels. Furthermore, the second autonomous motor vehicle 100 includes a second information gathering system 118 employing multiple second vehicle sensors 120, that are analogous in structure and functionality to the first vehicle sensors 20 employed by the first information gathering system 18, as described above. Similar to the first sensors 20 in the vehicle 10, the second vehicle sensors 120 may be part of other system(s) employed by the vehicle 20, such as for displaying a 360-degree view of the target surroundings 14.

According to the present disclosure, the second autonomous vehicle 100 generally enters the target surroundings 14 after the first autonomous vehicle 10 has exited the subject geographical area. Similar to first sensor(s) 20, second sensor(s) 120 is configured to detect the target surroundings 14, including capturing a raw second data set 124A, such as video images, gathered from the target surroundings. The raw second data set 124A is intended to be losslessly compressed within the vehicle 10 in a limited amount of time and with the most efficient usage of data storage, as will be described in detail below. Various specific features may also be extracted from the raw data set 124A depending on particular applications for which the raw data was accumulated, such as to display a 360-degree view of the target surroundings 14, as well as insert the raw data into a perception algorithm for semi-autonomous purposes.

Second sensor(s) 120 is also configured to transmit the raw second data set 124A gathered from the target surroundings 14 to a data processor arranged on the second vehicle 100, that will be described in detail below. As shown in FIG. 1, each information gathering system 18, 118 respectively includes a first processor 26 and a second processor 126. As shown, the processors 26, 126 operate as source encoders configured to compress gathered raw data, and thus, each is operatively connected, and may be physically mounted, to the respective first sensor 20 and second sensor 120, i.e., the individual sources of captured raw data. Each of the processors 26, 126 includes a memory that is tangible and non-transitory. The respective memory of the processors, 26, 126 may be a recordable medium that participates in providing computer-readable data or process instructions. Such a medium may take many forms, including either volatile or non-volatile media. The processors 26 and 126 may be small, purposely designed units for performing compression of gathered raw data. Each of the processors 26, 126 also employs an algorithm that may be implemented as an electronic circuit, such as a field-programmable gate array (FPGA), or saved to non-volatile memory. The compressed data produced by each of the processors 26, 126 may be sent to storage. Accordingly, the gathered raw data will not be decoded immediately, but rather at some later time (for example, for off-line learning).

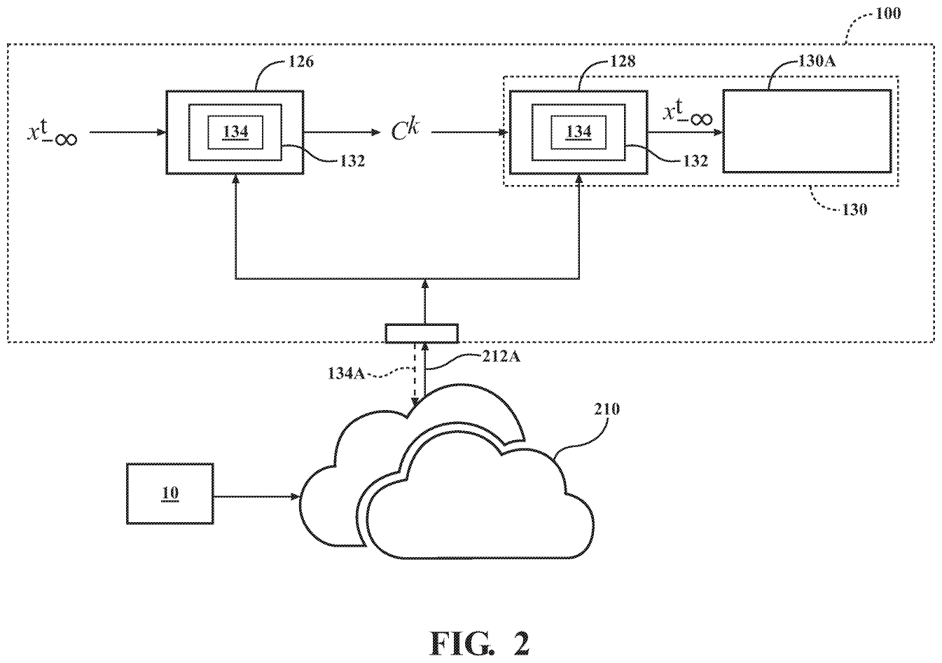

Additionally, each information gathering system 18 and 118 includes respective programmable electronic controllers 28 and 128. As shown in FIG. 2, the controllers 28, 128 may be integral to respective central processing units (CPUs) 30, 130, each arranged on the respective vehicle 10, 100. As depicted, the controllers 28, 128 are arranged on the respective autonomous vehicles 10, 100, and operate as decoders for the captured raw data received from the respective first and second processors 26, 126. The controllers 28, 128 may also be configured to use the captured raw data for various purposes such as to establish a 360-degree view of the target surroundings 14, to execute perception algorithms, etc. Each of the controllers 28, 128 includes a memory that is tangible and non-transitory. The memory may be a recordable medium that participates in providing computer-readable data or process instructions. Such a medium may take many forms, including but not limited to non-volatile media and volatile media. Non-volatile media used by the controllers 28, 128 may include, for example, optical or magnetic disks and other persistent memory. Each of the controllers 28, 128 includes an algorithm that may be implemented as an electronic circuit, e.g., FPGA, or as an algorithm saved to non-volatile memory.

Volatile media of each of the controllers' 28, 128 memory may include, for example, dynamic random-access memory (DRAM), which may constitute a main memory. Each of the controllers 28, 128 may communicate with the respective processors 26, 126 via a transmission medium, including coaxial cables, copper wire and fiber optics, including the wires in a system bus coupling a specific controller to an individual processor. Memory of each controller 28, 128 may also include a flexible disk, hard disk, magnetic tape, other magnetic medium, a CD-ROM, DVD, other optical medium, etc. Controllers 28, 128 may be equipped with a high-speed primary clock, requisite Analog-to-Digital (A/D) and/or Digital-to-Analog (D/A) circuitry, input/output circuitry and devices (I/O), as well as appropriate signal conditioning and/or buffer circuitry. Algorithms required by the controllers 28, 128 or accessible thereby may be stored in the memory and automatically executed to provide the required functionality.

Controllers 28, 128 may be configured, i.e., structured and programmed, to receive and process captured raw data signals gathered by the respective first and second sensors 20, 120. The controllers 28, 128 may also perform the decoding, i.e., decompression, and then transfer the raw captured data to additional algorithms, such as algorithms constructed to generate a 360-degree view or a perception of the object 22 and other items within the target surroundings 14. For exemplary purposes, each CPU 30, 130 is specifically programmed with respective perception software 30A, 130A that may include an artificial intelligence (AI) algorithm configured to assess incoming data from the respective first and second sensors 20, 120. Such respective CPUs 30, 130 may be configured to perform additional processing of the data, for example integrate several images into the 360-degree view or generate perception algorithms for autonomous driving. The perception software 30A, 130A would be generally configured to analyze and interpret the physical parameter data from the respective sensors 20, 120. For example, the perception software 30A, 130A may be configured to define a positioning of the object 22 in the X-Y-Z coordinate system (shown in FIG. 1) and identify the object 22 using a pre-trained AI algorithm.

The first and second information gathering systems 18, 118 are part of a data sequence processing system 200, which also includes an information technology (IT) cloud platform 210 configured to store and process IT cloud data or data set 212. Generally, an IT cloud platform is a provider-managed suite of hardware and software. An IT paradigm enables universal access to shared pools of configurable system resources and higher-level services that may be rapidly provisioned with minimal management effort, often over the Internet. Furthermore, cloud computing relies on sharing of resources to achieve coherence and economies of scale, similar to a public utility. The system 200 is assisted by the IT cloud platform 210 to achieve universal lossless compression of gathered sensor data, specifically of the raw second data set 124A gathered by the second sensor(s) 120.

To achieve such functionality of the system 200, each of the vehicles 10, 100 is configured to establish communication between the IT cloud platform 210 and the processors 26, 126 and controllers 28, 128, such as via respective vehicle communication units 31, 131. The respective communication units 31, 131 are arranged in the vehicles 10, 100 and are specifically configured to receive data from external sources, such as the IT cloud platform 210, and communicate the received data within the vehicle to the respective processors 26, 126 and controllers 28, 128. Requisite communication between the first and second vehicles 10, 100 and the IT cloud platform 210 may be cellular or via wireless local area networking (Wi-Fi) facilitated by a cloud edge residing on a cellular base station (not shown) for reduced latency or via an earth-orbiting satellite 220.

In general, data compression is useful because it reduces resources required to store, handle, and transmit the data. Computational resources are consumed in the compression process and, usually, in the reversal of the process (decompression). Data compression is subject to a space-time complexity trade-off. For instance, a compression scheme for video may require expensive hardware for the video to be decompressed fast enough to be viewed while it is being decompressed, as the option to decompress the video in full before the video is viewed may be inconvenient or require additional storage. Abstractly, a compression algorithm may be viewed as a function on sequences (normally of octets or bytes). Compression is successful if the resulting sequence is shorter than the original sequence (and the instructions for the decompression map). As specifically contemplated by the present disclosure, “universal compression” is source coding that permits data to be compressed with no prior knowledge of the data source's distribution. In information technology, data compression may be lossy or lossless.

Lossless compression is a class of data compression algorithms that allows the original data to be perfectly reconstructed from the compressed data, i.e., does not degrade the data, which permits the compression to be reversed. By contrast, the amount of data reduction possible using lossy compression is typically significantly higher than through lossless techniques, but such compression is irreversible. Lossy compression frequently uses a technique of partial data discarding and permits reconstruction only of an approximation of the original data to represent the content, which typically results in lost information. Specific designs of data compression schemes involve trade-offs among various factors, including the degree of compression, the amount of distortion introduced (when using lossy data compression), and the computational resources required to compress and decompress the data.

The lossless compression algorithm may be used on any gathered raw information with the assistance of the IT cloud platform 210. It provides both the assistance from the IT cloud platform 210 and defines the scope of the information the IT cloud platform should preserve and how that information may be integrated into a lossless compression algorithm to enhance the algorithm's performance. For example, in addition to autonomous driving, cameras on vehicles may also be used to provide the vehicle's operator with a 360-degree view of the vehicle's surroundings. This data may also be losslessly compressed and decoded before processing and providing the vehicle's operator such a 360-degree view. Such exemplary use of the losslessly compressed data to achieve the 360-degree view may not be related to autonomous driving. For expediency and clarity, however, the remainder of the present disclosure will primarily focus on an autonomous vehicle application of the IT cloud platform 210 assisted universal lossless data compression.

The first electronic controller 28 is configured to receive the compressed raw first data set 24A from the first vehicle sensor 20, process the raw first data set 24A, such as by decoding of the compressed first data set 24A. The first electronic controller 28 is also configured to communicate to the IT cloud platform 210 a processed first data set 24B indicative of a specific physical parameter or characteristic of the detected target surroundings 14. The IT cloud platform 210 is configured to merge, i.e., combine and integrate, the processed first data set 24B with the IT cloud data set 212 that may already be residing on the IT cloud platform, and thereby generate a combined data set 212A indicative of the subject characteristic of the target surroundings 14. Such combined data set 212A is stored by the IT cloud platform 210 as a number sequence or enumerations.

The order of numbers in the combined data set 212A sequence determines what the subject numbers refer to, such as to which symbol xₜ and in what context, i.e., the data structure surrounding the symbol, to be described in detail below. Each time the IT cloud platform 210 receives new data, such as the processed first data set 24B, the new data is combined with the previously stored data, and the newly combined data set 212A overwrites the combined data previously stored on the IT cloud. Accordingly, previous encounters of different or same vehicles with the target surroundings 14 would be used for integration of such data on the IT cloud platform 210 and may be accomplished off-line. The term “off-line” herein signifies that the subject integration of the data on the IT cloud platform 210 may be performed separately from, i.e., temporally outside of the raw data-gathering via vehicle(s) operating in the target surroundings 14.

The IT cloud platform 210 may also be configured to transmit the combined data set 212A to the second vehicle 100 as the second vehicle traverses the target surroundings 14. The IT cloud platform 210 may be specifically configured to communicate the combined data set 212A via the communication unit 131 to each of the second processor 126 and the second electronic controller 128 substantially in parallel. The in-vehicle communication between the second processor 126 and the second electronic controller 128 preserves the lossless property of the compression of the raw second data set 124A, and may be performed via a data network (not shown), e.g. a Controller Area Network (CAN bus), arranged in the vehicle 10. Specifically, the IT cloud platform 210 may communicate the combined data set 212A to a central communication unit 131 arranged in the vehicle 10. The vehicle central communication unit 131 may then transfer the received combined data set 212A to the second processor 126 and the second electronic controller 128.

The second processor 126 may be configured to perform an on-line, i.e., in real time, lossless compression of the raw second data set 124A using the combined data. set 212A. According to the present disclosure, the term “on-line” signifies that the lossless compression of the raw second data set 124A is performed during regular operation of the data sequence processing system 200 and as the second motor vehicle 100 is on the road, performing regular tasks. As such, “on-line” is herein contrasted with “off-line” solution for data compression, which would be performed temporally outside of regular operation of the subject raw data gathering vehicle. The analysis of the raw second data set 124A is intended to be performed frame-by-frame, e.g., by raster scanning the video image. In general, the scanning is performed sequentially (byte after byte) and the ordering of the scan is done by relevance, i.e., ordering the scan such that the next byte is highly correlated with a well-defined set of bytes already observed which are used to form a context. The relevant enumeration and calculation use a tree structure discussed in detail below. For example, in the raster scan the relevant bytes are the couple of bytes before the current byte in the current line, and bytes in the previous line in a similar location relative to the current byte. The second processor 126 may be further configured to shift parameters of the on-line lossless compression of the raw second data set 124A to provide an enhanced compression starting point. The compression of the raw second data set 124A is performed by determining a weighted probability P_{w} for the current symbol xₜ given the current context. This weighted probability P_{w} is produced from estimated probabilities in every possible sub-context up to the maximum length context. Following its lossless compression, the gathered raw second data set 124A is to be transferred within the second vehicle 100 between the second processor 126 and the controller 128 for further processing therein. Alternatively, the raw data following compression via processor, 26 or 126, instead of being communicated to the respective controller, 28 or 128, may be sent directly to storage. In such a case, the combined data set 212A must also be preserved in storage, so that lossless compression may be performed from the storage off-line, for example, to be used as training data in the development of improved algorithms.

As shown in FIG. 3, each of the second processor 126 and the electronic controller 128 may include a context tree weighted (CTW) compression algorithm 132. The CTW compression algorithm 132 includes a context tree data structure 134 with a context node 136A and a context buffer 138 data structure. More specifically, the second processor 126 uses the combined data from the IT cloud platform 210 to shift the parameters in each node of the context tree data structure 134 for the lossless compression of the raw second data set 124A. The subject shift of the parameters according to the combined data provides the enhanced compression compared to general CTW procedure by enhancing an initial probability estimation. The same shifting of the parameters is also performed in the controller 128, thereby preserving the lossless property of the compression process. While the two devices, second processor 126 and the controller 128 may operate substantially concurrently, the decoding in the controller 128 may commence before the entire encoding in the second processor has been completed. As the second processor 126 begins to encode, i.e., compress, and transmit the compressed bits, there is no need for the second processor to finish the compression of the entire data sequence before the controller 128 may start to receive the compressed bits and perform the decoding. The controller 128 may therefore perform the decoding without the need to wait to receive the end of the data sequence. In other words, such compression may be performed in real-time.

The context buffer 138 data structure is employed to perform the on-line lossless compression of the raw second data set 124A given the current context 138 via the CTW compression algorithm 132. Each of the second processor 126 and the electronic controller 128, may be configured to independently determine the weighted probability P_{w} of the symbol xₜ following the current context buffer (such as a particular pixel in a video file image) in the raw second data set 124A. Accordingly, the CTW compression algorithm 132 may be configured to determine the weighted probability P_{w} of symbols xₜ in the raw second data set 124A given the current context 138, by using the combined data set 212A to generate an enhanced or refined context tree data structure 134A. The enhanced context tree data structure 134A may then be communicated to the IT cloud platform 210 via the vehicle communication unit 131.

Specifically, for a given context 138, each of the second processor 126 and the electronic controller 128 determine a set of probabilities (the same set) which is based on the current values in the CTW compression algorithm 132. The subject set of probabilities is used for the encoding and decoding of the current symbol xₜ. The calculation of these probabilities is based on the estimated probabilities in each node of the CTW compression algorithm 132, such as the node 136A. The estimated probabilities in each node of the CTW compression algorithm 132 are then calculated according to the compression algorithm 132, which defines the enhancement as a result of the CTW compression algorithm taking into account the combined data set 212A, which shifts the calculation. Once the encoding and decoding of the current symbol xₜ is complete, the CTW compression algorithm 132 may be updated with an additional occurrence of the symbol xₜ (an update which changes the respective values of the estimated probabilities). Such enhancing of the context tree data structure 134 may be accomplished by shifting parameters in each of the second processor 126 and the electronic controller 128, in each node of the CTW compression algorithm 132 according to the combined data set 212A, to respectively encode and decode the symbol xₜ. These parameters enhance the calculation of the estimated probability in each node of the CTW compression algorithm 132. With resumed reference to FIG. 2, x_{-∞}^{t} denoted the entire raw data to be encoded and decoded. C^{k} denotes the compressed sequence of bits, the length of which is not initially known, so it is generally designated with a variable k.

The combined data set 212A sequence of enumerations in the IT cloud platform 210 is intended to be organized for correspondence to the context tree data structure 134, such that the combined data set 212A sequence of enumerations fits into the nodes 136A of the subject context tree. Each context node 136A in the context tree data structure 134, corresponds to a specific value and length of a particular context 138, wherein various analyzed contexts may have different (unequal) lengths. Furthermore, each context node 136A includes the combined data set 212A sequence of enumerations, and is denoted as variable “r”. Relevant enumerations for each possible value of the identified context 138 may be obtained by following a specific context path 134-1 value in the context tree data structure 134. Apart from the variable r, the data for which is received from the IT cloud platform 210, each node also has current enumerations a, which are based on the captured raw data set 124A, and also appear in the CTW compression algorithm 132. (The subject relevant enumerations a are generally available for compression processing, if the specific value of the identified symbol xₜ is identified as being very probable.

Following compression of the identified symbol xₜ, the second processor 126 (as well as the second electronic controller 128, once the subject controller has finished decoding of the identified symbol) may update the context tree data structure 134 to incorporate into the enumeration the appearance of the identified symbol xₜ. Of note, the context buffer 138 is also updated, in parallel with the context tree data structure 134, by shifting the symbols to the left and inserting the symbol xₜ in the location of symbol xₜ₋₁. However this is less relevant to this paragraph where the emphasis is on the reason of updating the enumerations in the CTW itself. Updating the context tree data structure 134 is generally accomplished for two purposes: 1) to refine compression of the raw second data set 124A, in case the raw second data does not fit well with the combined data set 212A, and 2) to send the compressed data sequence (tree of enumerations) to the IT cloud platform 210 to be combined and be used for processing the data gathered by another, i.e., next, vehicle to enter the target surroundings 14.

Specifically, the combined data set 212A is used to assess likely recurrence (probability) of each symbol in the relevant, i.e., statistically highly correlative, context 138. For example, statistical correlation in a relevant context 138 of the raw second data set 124A may be a recurring sequence of symbols likely to directly precede the identified symbol xₜ. The assessment may be accomplished by analyzing, frame-by-frame, the gathered raw second data set 124A captured by the second sensor 120, for example, a video file generated by the camera 120, to losslessly compress each symbol xₜ of the gathered raw second data. Each node in the context tree data structure 134 computes an estimated probability, which depends both on the combined data set 212A from the IT cloud platform 210 (denoted as r in the CTW compression algorithm 132) and the current enumerations (denoted as a in the CTW compression algorithm 132). In practice, for each identified symbol xₜ to be compressed, multiple possible contexts 138, i.e., nodes along the path 134-1 down the context tree data structure 134 that match the current context 138, will be analyzed. The difference between such possible contexts 138 is their length. The context tree data structure 134 may therefore generate enumerations for different context lengths up to length D (shown in FIG. 3).

The context tree data structure 134 ensures an arithmetic connection between the enumerations in a, where the preceding node 136A is always the summation of the enumerations of the subsequent nodes 136B (as shown in FIG. 3). However, the values of r in the combined data set 212A are not required to follow the above relationship to preserve the lossless property of compression. Because the connection between the values of is in the preceding node relative to the subsequent nodes do not need to be preserved, the data sets 24B and 212 may be combined on the IT cloud platform 210 according to other criteria, for example storage efficiency.

The basic CTW compression algorithm 132 was developed by Willems, Shtrakov, and Tjalkens in 1995, and uses of the Krichevsky-Trofimov estimator, generally referenced as “KT 1981”. In information theory, given an unknown stationary source π with alphabet A and a sample range w from π, the KT 1981 estimator produces a probability estimate Pₑ, or Paᵢ(w) estimator of the probability of each symbol aᵢ∈A. The Paᵢ estimator is generally considered optimal in the sense that it minimizes the worst-case regret asymptotically. The advantages for the context tree data structure 134 are that the Paᵢ estimator may be calculated sequentially, and it has a lower bound that allows us to upper bound “parameter redundancy”, uniformly for all θ in the expression below. For a binary alphabet and a string w with m zeroes and n ones, the KT estimator Paᵢ(w) is defined as:

$$Pe ( m , n ) = {\int }_{0}^{1} \frac{1}{π \sqrt{( 1 - θ ) θ )}} {( 1 - θ )}^{m} {θ}^{n} d θ$$

and the sequential calculation is as follows (wherein Pₑ(0,0)=1):

$${P}_{e} ( m + 1 , n ) = \frac{m + 1 / 2}{m + n + 1} {P}_{e} ( m , n )$$

$${P}_{e} ( m , n + 1 ) = \frac{n + 1 / 2}{m + n + 1} {P}_{e} ( m , n )$$

The CTW compression algorithm 132 includes a different estimator also suggested by the KT 1981 and referred to as the sample-based estimator Pₑ^{r} in place of the standard KT 1981 estimator Pₑ, and is defined according to the mathematical expression shown below:

$${P}_{e}^{r} = \int \frac{Γ ( {\sum }_{j} {r}_{j} + \frac{\vert A \vert}{2} )}{{\prod }_{j} Γ ( {r}_{j} + \frac{1}{2} )} {\prod }_{j} {θ}_{j}^{{r}_{j} + {a}_{j}} d θ \qquad ( 132 )$$

In the expression 132, the vector “a”, which is given for a specific sub-context up to the maximum length context, represents an enumeration of what was thus far observed in the raw second data set 124A subsequently after the specific sub-context according to the specific sequence gathered by the second sensor 120 of the second vehicle 100. The vector “r” represents an enumeration of what is observed in the combined data set 212A, and represents the shifting in the compression of the raw second data set 124A by the combined data set. The vector “r” may be unique for each respective context node 136A in the context tree data structure 134, and be selected independently. Therefore, using the combined data set 212A enumeration, the Pₑ^{r} is an estimator of an independent and identically distributed sequence with exactly aᵢ appearances of kᵢÅA, where kᵢ are symbols from the set A. Wherein, aᵢ is the value of i^{th} index in the vector a, which defines the substance of the vector a at a specific node, and is evaluated at each node 136A of the context tree data structure 134.

The method used in the context tree data structure 134 to calculate the weighted probability P_{w} is used in the encoding by the second processor 126. The enumerations a, as well as the shifting vector r, i.e., the combined IT data set 212A, influence the estimated probabilities in each node 136A according to the CTW compression algorithm 132. The weighted probability P_{w} is calculated from these estimated probabilities Pₑ according to the iterative equation in 0053. The calculation of the weighted probability P_{w} is performed as in the CTW algorithm by Willems et al. 1995, and given as follows:

P_{w}(context s)=½Pₑ^{r}^{ₛ}(aₛ)+½P_{w}^{{0 s}}P_{w}^{{1 2}}, for [symbol] (s)<D

P_{w}(context s)=Pₑ^{r}^{ₛ}(aₛ), for [symbol] (s)=D

The function [symbol] receives node s and returns its depth in the context tree data structure 134. The weighted probability P_{w} that is used for the compression (in both encoding and decoding) is the probability in the root of the context tree data structure 134. To calculate the subject probability P_{w}, the context tree data structure 134 is followed down the path 134-1 according to the context 138, and the sample-based estimators in each node are used along the path. All the nodes 136A and 136B are used along the path 134-1 that fit the context 138. The present sample-based estimator Pₑ^{r} uses the vector rₛ, i.e., including the combined information received from the IT cloud platform 210 for each node s of the specific context, and also the specific enumeration based on the raw data aₛ, which is also unique for each node in the context tree data structure 134.

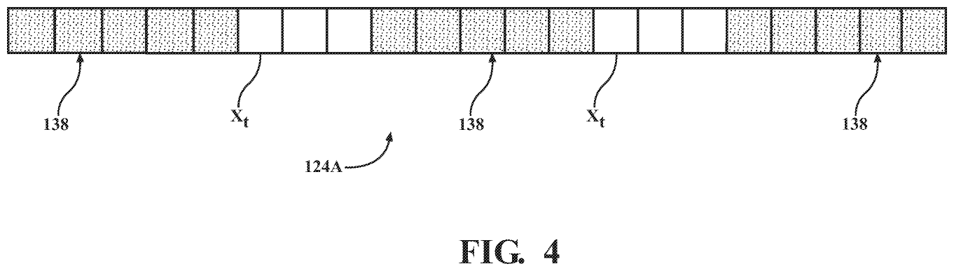

FIG. 4 illustrates a specific example of the raw second data set 124A being examined. The shaded locations in FIG. 4 denote a specific context 138 having a five-unit length. Given this specific context 138, the first location right after the subject context shown in FIG. 4, i.e., the first of the sequence of three unshaded units or symbols xₜ, is examined. Extracting these “next location” symbols out of the entire sequence of raw second data set 124A will provide a sub-sequence, which is assumed (for the specific node matching the subject context having a five-unit length) to be an independent and identically distributed sequence. The sample-based estimator Pₑ^{r} provides an estimate of probability of the subject sequence under such assumptions, and thus corresponds to a specific node 136A and matches the specific context 138 in the context tree data structure 134 shown in FIG. 3.

The processor 126 and the electronic controller 128 may thus update the probability of occurrence of the identified symbol xₜ according to the currently observed sequence of data, i.e., the raw second data set 124A using the vector a in each node, according to the CTW compression algorithm 132. As discussed above, to calculate of the probability P_{w} of symbol xₜ the second processor 126 and the second electronic controller 128 go down the context tree path 134-1. In each node, the second processor 126 and the second electronic controller 128 use the sample-based estimator which take into account the past occurrences of the symbol xₜ observed in the relevant contexts. After the subject encoding and decoding, these nodes are updated with the additional occurrence, and the sample-based estimator Pₑ^{r} is also updated along the path 134-1.

Using the approach embodied in the expression 132, the second processor 126 may be configured to generate a relatively shorter encoded sequence of bits (encoding units of memory) via on-line lossless compression of the raw second data set 124A as a result of a relatively higher determined probability P_{w} from the current context 138. And, alternatively, the second processor 126 may generate a relatively longer encoded sequence of bits as a result of a relatively lower determined probability P_{w} from the current context 138. In other words, if the sequence is more probable, then its compressed version will be shorter, since the determination of what is probable is derived from the sequence itself. As in the CTW algorithm by Willems et al. 1995, the weighted probability P_{w} is then inserted to an arithmetic encoder/decoder to produce the encoded/decoded sequence.

The losslessly compressed raw second data set 124A may subsequently be communicated or transmitted from the second processor 126 to the second electronic controller 128. This transmission may be accomplished in real-time, i.e., as described above, portions of data may be transmitted according to a specific transmission protocol without waiting until the entire sequence is compressed. The second electronic controller 128 may in turn decode the losslessly compressed raw second data set 124A and process the decoded second data set to generate the enhanced or updated context tree data structure 134A using the IT cloud combined data set 212A. The update of the context tree data structure 134 is accomplished after each decoding step based on the decoded symbol xₜ, which permits the enumerations of the context tree data structure to be updated and prepared for the next decoding step.

Furthermore, the updated context tree data structure 134 may be transmitted from the second vehicle 100 to the IT cloud platform 210 and merged with the combined data set 212A to transfer to another, subsequent to second vehicle 100, autonomous vehicle that passes through the target surroundings 14. In other words, the second electronic controller 128 may be configured to communicate the updated context tree data structure 134, for example as part of processed second data set 124B, to the IT cloud platform 210 as the second vehicle 100 exits or after the second vehicle 100 has exited the target surroundings 14. This cycle of using the IT cloud platform 210 data to losslessly compress and process raw new data, such as the second data set 124A, gathered by vehicles entering the target surroundings 14, and then combining the processed new data with the IT cloud data may be repeated for as many vehicles as may pass through the target surroundings 14. Accordingly, the IT cloud platform 210 may include provisions for long-term storage of the combined data set 212A to facilitate lossless compression of newly gathered data by additional vehicles passing through the particular terrain identified by the target surroundings 14.

The IT cloud platform 210 may also be configured to sort and/or group, the combined data set 212A according to predetermined categories and/or criteria, e.g., time of day, day of the week, day of the month, the four seasons of the year. etc. Additionally, the specific criteria and the resolution within a particular criterion may be selected in relation to available storage capacity of the IT cloud platform 210. Therefore, the previously stored IT platform data set 212 may be sorted according to such criteria. The first data set 24A gathered by the first vehicle sensor(s) 20 may then be correspondingly sorted and then combined with the previously stored IT platform data 212. The resultant sorted combined data set 212A may then be transmitted to the second vehicle 100.

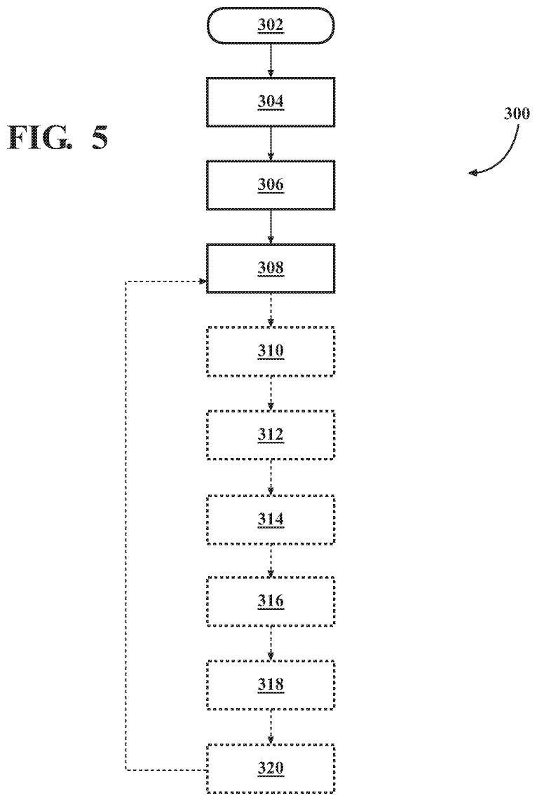

FIG. 5 depicts a method 300 of data sequence processing for an information gathering system, such as the second information gathering system 118 of the second vehicle 100, as described above with respect to FIGS. 1-4. The method 300 may be performed via the data sequence processing system 200 assisted by the IT cloud platform 210 and utilizing the second processor 126 and the second electronic controller 128 programmed with respective data compression algorithms. The method 300 initiates in frame 302 with the first vehicle 10 situated relative to or physically traversing the target surroundings 14 that includes the object 22. Following frame 302, the method proceeds to frame 304, where the method includes detecting, via the first sensor(s) 20, the target surroundings 14 proximate the first vehicle 10.

After frame 304, the method advances to frame 306. In frame 306 the method includes communicating, to the IT cloud platform 210 via the first electronic controller 28, the processed first data set 24B indicative of a characteristic of the detected target surroundings 14. Following frame 306, the method proceeds to frame 308. In frame 308 the method includes merging, on the IT cloud platform 210, the first data set 24B with the IT cloud data set 212 residing on the IT cloud platform 210 to generate the combined data. set 212A indicative of the characteristic of the target surroundings 14. Following frame 308, the method may access frame 310. In frame 310 the method includes transmitting the combined data set 212A, from the IT cloud platform 210 to the second vehicle 100 (equipped with the second processor 126 and the second electronic controller 128) traversing the target surroundings 14. In frame 310, as described above with respect to FIGS. 1-4, the method may also include sorting the combined data set 212A on the IT cloud platform 210 according to the predetermined criteria prior to transmitting the combined data set to the second vehicle 100. After frame 310, the method may advance to frame 312.

In frame 312 the method includes communicating the combined data set 212A to each of the processor 126 and the electronic controller 128 via the vehicle communication unit 131. Following frame 312 the method may advance to frame 314. In frame 314 the method includes detecting the target surroundings 14, via the second sensor 120 arranged on the second vehicle 100 and in communication with the second processor 126. After frame 314, the method may advance to frame 316. In frame 316 the method includes communicating, via the second sensor 120 to the second processor 126, the raw second data set 124A gathered from the detected target surroundings 14. After frame 316, the method may proceed to frame 318. In frame 318, the method includes performing an on-line lossless compression of the raw second data set 124A, via the second processor 126, using the combined data set 212A.

In frame 318, as described with respect to FIGS. 1-4, the on-line lossless compression of the raw second data set 124A may include employing the CTW compression algorithm 132 having a context tree data structure 134 with at least one context node 136A and the context buffer 138 data structure. Employing the CTW compression algorithm 132 may include determining the probability of occurrence of the identified symbol xₜ in the raw second data set 124A in each context node 136A of the CTW compression algorithm using the enhanced context tree data structure 134A. Furthermore, the CTW compression algorithm 132 may use the sample-based estimator of probability of occurrence of the sequence of symbols xₜ for every sub-context defined according to the mathematical expression defined according to the above-described mathematical expression 132:

$${P}_{e}^{r} = \int \frac{Γ ( {\sum }_{j} {r}_{j} + \frac{\vert A \vert}{2} )}{{\prod }_{j} Γ ( {r}_{j} + \frac{1}{2} )} {\prod }_{j} {θ}_{j}^{{r}_{j} + {a}_{j}} d θ$$

Performing the on-line lossless compression of the raw second data set 124A in frame 318 may include generating a relatively shorter encoded sequence of bits in response to a relatively higher determined weighted probability in the respective context tree. Additionally, performing the on-line lossless compression of the raw second data set 124A in frame 318 may include generating a relatively longer encoded sequence of bits in response to a lower determined weighted probability in the respective context tree.

Following frame 318, such as after the second vehicle 100 has exited the target surroundings 14, the method may access frame 320. In frame 320 the method may include updating the IT cloud platform 210 data, such as the combined data set 212A, with the enhanced context tree data structure 134A. Specifically, the enhanced context tree data structure 134A may be communicated to the IT cloud platform 210 via the vehicle communication unit 131. Following frame 320 the method may return to frame 308. The method 300 may thus continuously update and use the IT cloud platform 210 data to process and losslessly compress newly gathered raw data, such as the raw second data set 124A, gathered by vehicles entering the target surroundings 14. To facilitate repeated lossless compression of newly gathered raw data by vehicles passing through the target surroundings 14, the method 300 may employ long-term storage of the combined data set 212A on the IT cloud platform 210.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of data sequence processing assisted by an information technology (IT) cloud platform, the method comprising:
detecting target surroundings, via a first sensor arranged on a first vehicle traversing the target surroundings;
communicating, to the IT cloud platform via a first electronic controller arranged on the first vehicle, a processed first data set indicative of a characteristic of the detected target surroundings; and
merging, on the IT cloud platform, the processed first data set with an IT cloud data set residing on the IT cloud platform to generate a combined data set indicative of the characteristic of the target surroundings,

2. The method according to claim 1, further comprising transmitting the combined data set, from the IT cloud platform to a vehicle communication unit arranged in a second vehicle traversing the target surroundings and having a processor and a second electronic controller, and communicating the combined data set to each of the processor and the electronic controller via the vehicle communication unit.

3. The method according to claim 2, further comprising sorting the combined data set on the IT cloud platform according to a predetermined criteria prior to transmitting the combined data set to the second vehicle.

4. The method according to claim 2, further comprising:
detecting the target surroundings, via a second sensor arranged on the second vehicle and in communication with the processor;
communicating, via the second sensor to the processor, a raw second data set gathered from the detected target surroundings; and
performing an on-line lossless compression of the raw second data set, via the processor, using the combined data set from the IT cloud platform.

5. The method according to claim 4, wherein the on-line lossless compression of the raw second data set includes employing a context tree weighted (CTW) compression algorithm having a context tree data structure with at least one context node and a context buffer data structure.

6. The method according to claim 5, wherein employing the CTW compression algorithm includes determining, independently via each of the processor and the second electronic controller, a weighted probability of occurrence of a symbol in the raw second data set given a current context by using the combined data set to generate an enhanced context tree data structure.

7. The method according to claim 6, wherein the CTW compression algorithm uses a sample-based estimator of probability of occurrence of the symbol defined according to the mathematical expression:
$${P}_{e}^{r} = \int \frac{Γ ( {\sum }_{j} {r}_{j} + \frac{\vert A \vert}{2} )}{{\prod }_{j} Γ ( {r}_{j} + \frac{1}{2} )} {\prod }_{j} {θ}_{j}^{{r}_{j} + {a}_{j}} d θ$$

8. The method according to claim 6, wherein performing the on-line lossless compression of the raw second data set includes:
generating a relatively shorter encoded sequence of bits in response to a relatively higher determined probability; and
generating a relatively longer encoded sequence of bits in response to a lower determined probability.

9. The method according to claim 6, further comprising communicating the enhanced context tree data structure to the IT cloud platform via the vehicle communication unit.

10. The method according to claim 1, wherein the IT cloud platform includes long-term storage of the combined data set.

11. A data sequence processing system comprising:
an information technology (IT) cloud platform;
a first sensor arranged on a first vehicle traversing the target surroundings configured to detect target surroundings; and
a first electronic controller arranged on the first vehicle configured to communicate to the IT cloud platform a processed first data set indicative of a characteristic of the detected target surroundings;
wherein the IT cloud platform is configured to merge the processed first data set with an IT cloud data set residing on the IT cloud platform, and thereby generate a combined data set indicative of the characteristic of the target surroundings.

12. The system according to claim 11, wherein the IT cloud platform is also configured to transmit the combined data set to a vehicle communication unit arranged in a second vehicle traversing the target surroundings and having a processor and a second electronic controller, and wherein the vehicle communication unit is configured to communicate the combined data set to each of the processor and the second electronic controller.

13. The system according to claim 12, wherein the IT cloud platform is additionally configured to sort the combined data set according to a predetermined criteria prior to transmitting the combined data set to the second vehicle.

14. The system according to claim 12, further comprising a second sensor arranged on the second vehicle and in communication with the processor, wherein the second sensor is configured to detect the target surroundings and communicate the target surroundings to the processor, a raw second data set gathered from the detected target surroundings, wherein the processor is configured to perform an on-line lossless compression of the raw second data set using the combined data set from the IT cloud platform.

15. The system according to claim 14, wherein the processor includes a context tree weighted (CTW) compression algorithm having a context tree data structure with at least one context node and a context buffer data structure to perform the on-line lossless compression of the raw second data set.

16. The system according to claim 15, wherein the CTW compression algorithm is configured to determine, independently via each of the processor and the second electronic controller, a weighted probability of occurrence of a symbol in the raw second data set given a current context by using the combined data set to generate an enhanced context tree data structure.

17. The system according to claim 16, wherein the CTW compression algorithm uses a sample-based estimator of probability of occurrence of the symbol for every sub-context defined according to the mathematical expression:
$${P}_{e}^{r} = \int \frac{Γ ( {\sum }_{j} {r}_{j} + \frac{\vert A \vert}{2} )}{{\prod }_{j} Γ ( {r}_{j} + \frac{1}{2} )} {\prod }_{j} {θ}_{j}^{{r}_{j} + {a}_{j}} d θ$$

18. The system according to claim 16, wherein the processor is additionally configured to perform the on-line lossless compression of the raw second data set to:
generate a relatively shorter encoded sequence of bits in response to a relatively higher determined probability; and
generate a relatively longer encoded sequence of bits in response to a lower determined probability.

19. The system according to claim 16, wherein the vehicle communication unit is further configured to communicate the enhanced context tree data structure to the IT cloud platform.

20. The system according to claim 11, wherein the IT cloud platform includes long-term storage of the combined data set.
